(19) United States
(12) Patent Application Publication
(10) Pub. No.: US 2022/0161602 A1
(43) Pub. Date: May 26, 2022

(54) PNEUMATIC RADIAL TIRE

(71) Applicant: The Yokohama Rubber Co., LTD., Tokyo (JP)

(72) Inventors: Hiroki FUJIMORI, Kanagawa (JP); Shinya HARIKAE, Kanagawa (JP)

(21) Appl. No.: 17/309,988

(22) PCT Filed: Dec. 12, 2019
(86) PCT No.: PCT/JP2019/048774

§ 371 Date: Jul. 8, 2021

(30) Foreign Application Priority Data
Jan. 10, 2019 (JP) 2019-002890

(51) Int. Cl. B60C 9/20

(52) U.S. Cl. CPC B60C 9/2009; B60C 2009/2093; B60C 2009/2096; B60C 2009/2077

(57) ABSTRACT

A pneumatic radial tire is provided that includes belt layers disposed on an outer circumferential side of a carcass layer in a tread portion, and a belt cover layer disposed on an outer circumferential side of the belt layers, the belt cover layer including organic fiber cords helically wound along a tire circumferential direction, the belt layers including steel cords arranged at an incline with respect to the tire circumferential direction in such a manner as to intersect one another between the layers, each of the belt layers having a bending rigidity of 16500 N·mm²/₅0 mm or less per 50 mm width in a direction orthogonal to a longitudinal direction of the steel cords, and the belt cover layer including organic fiber cords having an elongation of 2.0% to 4.0% under a load of 2.0 cN/dtex, the organic fiber cords being helically wound along the tire circumferential direction.

### TECHNICAL FIELD

The present technology relates to a pneumatic radial tire including a belt cover layer formed of organic fiber cords, and particularly relates to a pneumatic radial tire that provides improved durability while effectively reducing road noise.

### BACKGROUND ART

In pneumatic radial tires for a passenger vehicle or a light truck, a carcass layer is mounted between a pair of bead portions, a plurality of belt layers are disposed on an outer circumference side of the carcass layer in a tread portion, and a belt cover layer including a plurality of organic fiber cords helically wound along the tire circumferential direction is disposed on an outer circumference side of the belt layer. The organic fiber cords used in such a belt cover layer are mainly nylon fiber cords. However, in recent years, use of inexpensive polyethylene terephthalate fiber cords (hereinafter referred to as

PET fiber cords), which are more elastic than nylon fiber cords (for example, see Japan Unexamined Patent Publication No. 2001-063312), has been proposed. In a configuration where a belt cover layer formed of such high-elasticity PET fiber cords are used, the frequency of vibration occurring in the pneumatic tire during traveling tends to shift into a band that is less likely to cause resonance with the vehicle. As a result, mid-range frequency road noise can be effectively suppressed.

On the other hand, in a configuration where high-elasticity PET fiber cords are used in the belt cover layer, there is a tendency that interlayer shear strain is increased at shoulder portions, which are subjected to a large amount of deformation, making the belt cover layer likely to be separated. Furthermore, a high bending rigidity of steel cords used in the belt layers may cause the ends of the belt layers to be curled during a cutting step, leading to a splice defect that causes belt-edge-separation. Thus, there has been a demand for measures for improving, in a case where the belt cover layer (high-elasticity PET fiber cords) is combined with the belt layers (steel cords having a high bending rigidity), durability against belt layer separation while achieving the above-described road noise suppression effect.

### SUMMARY

The present technology provides a pneumatic radial tire including a belt cover layer formed of organic fiber cords, enabling improvement of durability while effectively reducing road noise.

An embodiment of the present technology provides a pneumatic radial tire comprising a tread portion extending in a tire circumferential direction and having an annular shape, a pair of sidewall portions respectively disposed on both sides of the tread portion, and a pair of bead portions each disposed on an inner side of the pair of sidewall portions in a tire radial direction, the pneumatic radial tire including a carcass layer mounted between the pair of bead portions, a plurality of belt layers disposed on an outer circumferential side of the carcass layer in the tread portion, and a belt cover layer disposed on an outer circumferential side of the belt layer, the belt layers comprising steel cords arranged at an incline with respect to the tire circumferential direction in such a manner as to intersect one another between the layers, each of the belt layers having a bending rigidity S of 16500 N·mm²/₅₀ mm or less per 50 mm width in a direction orthogonal to a longitudinal direction of the steel cords, and the belt cover layer comprising polyester fiber cords having an elongation of 2.0% to 4.0% under a load of 2.0 cN/dtex, the polyester fiber cords being helically wound along the tire circumferential direction.

In the present technology, by using, in the belt cover layer, polyester fiber cords having an elongation of from 2.0% to 4.0% under a load of 2.0 cN/dtex, the frequency of vibration occurring in the pneumatic tire during traveling can be shifted to a band that is less likely to cause resonance with the vehicle, thus enabling a reduction in mid-range frequency road noise and improvement of noise performance. On the other hand, because the bending rigidity S of the belt layer is set as described above, a splice defect in the belt layers is suppressed, and durability can be improved.

In the present technology, preferably, the steel cords have a 2+N structure in which an outer layer comprising N wire strands is intertwined around an inner layer comprising two wire strands that are bunched, and the number N of the wire strands of the outer layer is from one to four. Using steel cords having a flat cross-sectional shape is advantageous in suppressing warpage of belt members and suppressing a splice defect in the belt layers to improve durability.

In the present technology, preferably, the wire strands constituting the inner layer of the steel cords have a straightness of 120 mm/40 cm or less, and the bending rigidity S of the belt layers is 7500 N·mm²/₅0 mm or less. Setting within this range is advantageous in suppressing warpage of the belt members and suppressing a splice defect in the belt layers to improve durability.

Note that, in the present technology, the bending rigidity S of the belt layers per 50 mm width in a direction orthogonal to the longitudinal direction of the steel cords is measured in compliance with JIS (Japanese Industrial Standard) Z2248 as follows. First, the belt layers are extracted from the pneumatic radial tire, and a cut sample having a width of 50 mm in the direction orthogonal to the longitudinal direction of the steel cords is cut out. Then, the cut sample is supported such that a distance L (mm) between support points is 50 mm, and the center position between the support points is pressed in the vertical direction. At this time, a pressing speed is set to 10 mm/min, and the amount of strain Y (mm) in the pressing direction of the cut sample is measured in a case where the load W (N) reaches 6.0 N. The bending rigidity S of the above-described belt layers per 50 mm width in the direction orthogonal to the longitudinal direction of the steel cords (N·mm²/₅0 mm) is calculated from Formula (1) based on the distance L between the support points (L=50 mm), the load W (W=6.0 N), and the amount of strain Y.

S=(L³/48)×(W/Y) (1)

In the present technology, the straightness of the wire strands constituting the inner layer of the steel cords is measured in compliance with JIS G3510 as follows. First, the belt layers are extracted from the pneumatic radial tire, and the two wire strands constituting the inner layer of the steel cords are removed. Then, test pieces obtained by cutting each of the wire strands to a length of 40 cm are left on a measurement support having a smooth and hard flat surface in an open state in which the test pieces are not dynamically constrained. A ruler is placed along a straight line connecting both ends of the test piece, and the distance between the straight line and a point where the straight line intersects a perpendicular line extended from the vertex of the test piece is measured as the straightness (mm/40 cm).

### BRIEF DESCRIPTION OF DRAWINGS

FIG. 1 is a meridian cross-sectional view illustrating a pneumatic radial tire according to an embodiment of the present technology.

FIG. 2 is an explanatory diagram schematically illustrating a structure of a belt cord.

### DETAILED DESCRIPTION

Configurations of embodiments of the present technology will be described in detail below with reference to the accompanying drawings.

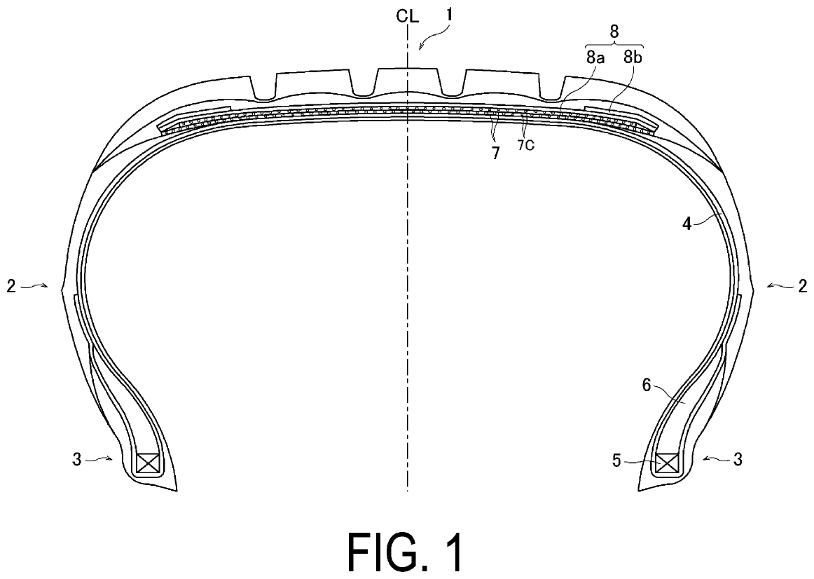

As illustrated in FIG. 1, a pneumatic tire of an embodiment of the present technology includes a tread portion 1, a pair of sidewall portions 2 disposed on both sides of the tread portion 1, and a pair of bead portions 3 disposed in the sidewall portions 2 at an inner side in a tire radial direction. Note that “CL” in FIG. 1 denotes a tire equator. Although not illustrated in FIG. 1 as FIG. 1 is a meridian cross-sectional view, the tread portion 1, the sidewall portions 2, and the bead portions 3 each extend in a tire circumferential direction to form an annular shape. Thus, a toroidal basic structure of the pneumatic tire is configured. Although the description using FIG. 1 is basically based on the illustrated meridian cross-sectional shape, all of the tire components each extend in the tire circumferential direction and form the annular shape.

In the illustrated example, a plurality of main grooves (four main grooves in the illustrated example) extending in the tire circumferential direction are formed in an outer surface of the tread portion 1, but the number of main grooves is not particularly limited. In addition to the main grooves, various grooves and sipes including lug grooves that extend in the tire width direction can also be formed.

A carcass layer 4 including a plurality of reinforcing cords extending in the tire radial direction is mounted between the pair of left and right bead portions 3. A bead core 5 is embedded in each of the bead portions 3, and a bead filler 6 having a generally triangular cross-section is disposed on the outer circumference of the bead core 5. The carcass layer 4 is folded back around the bead core 5 from the inner side to the outer side in the tire width direction. Accordingly, the bead core 5 and the bead filler 6 are wrapped by a body portion of the carcass layer 4 (the portion extending from the tread portion 1 through each of the sidewall portions 2 to each of the bead portions 3) and a folded back portion of the carcass layer 4 (the portion folded back around the bead core 5 at each of the bead portions 3 to extend toward each of the sidewall portions 2). For example, polyester fiber cords are preferably used as the reinforcing cords for the carcass layer 4.

A plurality (in the illustrated example, two layers) of belt layers 7 are embedded on an outer circumferential side of the carcass layer 4 in the tread portion 1. The belt layers 7 each include a plurality of reinforcing cords 7C that are inclined with respect to the tire circumferential direction, with the reinforcing cords 7C intersecting one another between the layers. In the belt layers 7, the inclination angle of the reinforcing cords 7C with respect to the tire circumferential direction is set ranging, for example, from 10° to 40°. Steel cords are used as the reinforcing cords 7C of the belt layers 7 (“reinforcing cords 7C” may hereinafter be referred to as “steel cords 7C”). In the belt layers 7 of the present technology, a bending rigidity S of each of the belt layers 7 per 50 mm width in the direction orthogonal to the longitudinal direction of the steel cords 7C is set to 16500 N·mm²/₅0 mm or less, and preferably 7500 N·mm²¹50 mm or less. Note that an excessively low bending rigidity S may prevent cornering power from being produced, leading to impaired steering stability. Therefore, the bending rigidity S may more preferably be set to 1200 N·mm²/₅0 mm.

To improve high-speed durability, a belt cover layer 8 is provided on an outer circumference side of the belt layers 7. The belt reinforcing layer 8 includes organic fiber cords oriented in the tire circumferential direction. In the belt reinforcing layer 8, the angle of the organic fiber cords with respect to the tire circumferential direction is set, for example, to from 0° to 5° . In the present technology, the belt cover layer 8 necessarily includes a full cover layer 8a entirely covering the belt layers 7, and optionally includes a pair of edge cover layers 8b that respectively locally cover both ends of the belt layers 7 (in the illustrated example, the belt cover layer 8 includes both the full cover layer 8a and the edge cover layers 8b). The belt cover layer 8 may be formed by helically winding, in the tire circumferential direction, a strip material obtained by bunching at least one organic fiber cord and covering the bunched organic fiber cord with coating rubber, and preferably has a jointless structure.

In particular, in the present technology, polyester fiber cords having an elongation of from 2.0% to 4.0% under a load of 2.0 cN/dtex are used as the organic fiber cords constituting the belt cover layer 8. Examples of the polyester fibers can include polyethylene terephthalate fibers (PET fibers). Note that in the present technology, the elongation under a load of 2.0 cN/dtex is the elongation ratio (%) of sample cords measured under a load of 2.0 cN/dtex when a tensile test is conducted in compliance with “Test Methods for Chemical Fiber Tire Cords” in JIS-L1017 and at a grip spacing of 250 mm and a tensile speed of 300±20 mm/min.

By thus combining, for use, the belt layers 7 having a specific physical property (bending rigidity) and the belt cover layer 8 formed of organic fiber cords (polyester fiber cords) having a specific physical property, durability can be improved while improving road noise performance. In other words, the physical property of the organic fiber cords in the belt cover layer 8 enables the frequency of vibration occurring in the pneumatic tire during traveling to be shifted to a band that is less likely to cause resonance with the vehicle, allowing road noise performance to be improved. On the other hand, the above-described bending rigidity S of the belt layers 7 allows warpage at the time of the belt members (the stage of materials before layering with other tire components) to be suppressed, thus suppressing a splice defect in the belt layers 7 caused by the warpage. This allows improvement of durability against separation of the belt layers 7.

At this time, in a case where the bending rigidity S of the belt layers 7 exceeds 16500 N·mm²/₅0 mm, warpage of the belt members fails to be suppressed, and a splice defect occurs, precluding separation of the belt layers 7 from being prevented. In a case where the elongation of the organic fiber cords constituting the belt cover layer 8 is less than 2.0% under a load of 2.0 cN/dtex, fatigue resistance of the organic fiber cords decreases and durability against separation is degraded. In a case where the elongation of the organic fiber cords constituting the belt cover layer 8 exceeds 4.0% under a load of 2.0 cN/dtex, road noise performance fails to be sufficiently improved.

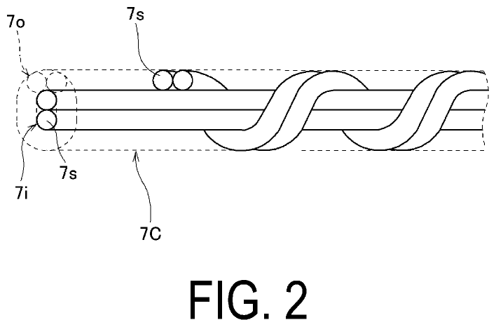

As illustrated in FIG. 2, the steel cords 7C constituting the belt layers 7 preferably have a 2+N structure (in the example in FIG. 2, a 2+2 structure) in which an outer layer 7o formed of N wire strands 7s is intertwined around an inner layer 7i formed of two bunched wire strands 7s. In the present technology, the number N of the wire strands 7s of the outer layer 7ois preferably from 1 to 4. In this structure, the cross-sectional shape of the steel cords 7C is flattened, and thus by arranging the steel cords 7C such that the direction in which the diameter of the steel cords 7C relatively increases in a cross section orthogonal to the longitudinal direction of the steel cords 7C extends along the width direction of the belt layers 7, warpage of the belt members can be effectively suppressed, and a splice defect in the belt layers 7 is suppressed, allowing durability to be effectively improved. In a case where the steel cords 7C do not have the structure described above, the cross-section of the steel cords 7C is not flattened, and the effect of improving durability due to the flattened shape of the steel cords 7C is not obtained. In a case where the number N of the wire strands 7s of the outer layer 7o exceeds four, the production stability of the cords and penetration of rubber of the cords are degraded.

At this time, the straightness of the wire strands 7s constituting the inner layer 7i of the steel cords 7C may preferably be 120 mm/40 cm or less. In a case where the inner layer 7i is formed of two bunched wire strands 7s as described above, the straightness of the wire strands 7s constituting the inner layer 7i contributes greatly to the warpage of the belt members. Thus, by setting the straightness within the above-described range, warpage of the belt members can be more effectively suppressed. This configuration is advantageous in suppressing a splice defect in the belt layers 7 to improve durability. In a case where the straightness of the wire strands 7s constituting the inner layer 7i of the steel cords 7C exceeds 120 mm/40 cm, the warpage of the belt members cannot be sufficiently suppressed, and the effect of improving durability is limited. Note that in cases where the steel cords 7C having this structure are used, the bending rigidity S of the belt layers 7 is preferably set to 7500 N·mm²/50 mm or less. In other words, cooperation between the effect of the structure of the steel cords 7C (straightness of the wire strands) and the effect of the physical property of the belt layers 7 (bending rigidity) enables durability to be more effectively improved.

The amount of steel cords is defined as the product of the cross-sectional area (mm²) of the steel cords 7C and the number of the steel cords 7C per 50 mm width (the number of cords/50 mm) in the direction orthogonal to the longitudinal direction of the steel cords 7C. Based on this definition, the amount of the steel cords may preferably range from 4 to 25. Accordingly, the belt layers 7 have a favorable structure, and this is advantageous in preventing separation of the belt layers 7 to improve durability. In a case where the amount of steel cords is less than 4, the ratio of the steel cords 7C to the belt layers 7 decreases, and thus steering stability may be degraded. In a case where the amount of steel cords exceeds 25, the effect of preventing separation fails to be sufficiently obtained. The individual numerical ranges of the cross-sectional area of the steel cords 7C and the number of cords are not particularly limited. However, the cross-sectional area of the steel cords 7C can be set ranging, for example, from 0.12 mm² to 0.63 mm², and the number of cords can be set ranging, for example, from 25 cords/50 mm to 45 cords/50 mm.

In a case where polyethylene terephthalate fiber cords (PET fiber cords) are used as the organic fiber cords constituting the belt reinforcing layer 8, PET fiber cords having an elastic modulus of 3.5 cN/(tex·%) to 5.5 cN/(tex·%) at a load of 44N at 100° C. are preferably used. By using PET fiber cords with the specific physical property described above, road noise can be effectively reduced while successfully maintaining the durability of the pneumatic radial tire. In a case where the PET fiber cords have an elastic modulus of less than 3.5 cN/(tex·%) under a load of 44 N at 100° C., the mid-range frequency road noise cannot be sufficiently reduced. In a case where the PET fiber cords have an elastic modulus of more than 5.5 cN/(tex·%) under a load of 44 N at 100° C., the fatigue resistance of the cords decreases, and the durability of the tire is degraded. Note that in the present technology, the elastic modulus under a load of 44 N at 100° C. [N/(tex·%)] is calculated by conducting a tensile test in compliance with “Test Methods for Chemical Fiber Tire Cords” in JIS-L1017 and at a grip spacing of 250 mm and a tensile speed of 300±20 mm/minute, and converting the inclination of a tangent line at a point on a load-elongation curve which corresponds to a load of 44 N, into a value per 1 tex. In a case where polyethylene terephthalate fiber cords (PET fiber cords) are used as the organic fiber cords constituting the belt reinforcing layer 8, the PET fiber cords preferably have a heat shrinkage stress at 100° C. of 0.6 cN/tex or more. By setting the heat shrinkage stress at 100° C. in this way, road noise can be effectively reduced while successfully maintaining the durability of the pneumatic radial tire. In a case where the PET fiber cords have a heat shrinkage stress at 100° C. of less than 0.6 cN/tex, a hoop effect during traveling fails to be sufficiently improved, leading to difficulty in sufficiently maintaining high-speed durability. The upper limit value of the heat shrinkage stress of the PET fiber cords at 100° C. is not particularly limited, but need only be 2.0 cN/tex, for example. Note that, in the present technology, the heat shrinkage stress (cN/tex) at 100° C. is the heat shrinkage stress of sample cords measured in a case where the sample cords are heated in compliance with “Test Methods for Chemical Fiber Tire Cords” in JIS-L1017 and at a sample length of 500 mm and at 100° C.×5 minutes.

In order to obtain PET fiber cords having the physical property as described above, for example, a dip treatment may be properly set. In other words, before a calendaring step, a dip treatment with an adhesive is performed on the PET fiber cords, and preferably, in a normalizing step after two-bath treatment, the ambient temperature is set ranging from 210° C. to 250° C., and the cord tension is set ranging from 2.2×10⁻²N/tex to 6.7×10⁻²N/tex.

Accordingly, desired physical properties such as those described above can be imparted to the PET fiber cords. In a case where cord tension in the normalizing step is less than 2.2×10⁻²N/tex, the cord elastic modulus is reduced, preventing the mid-range frequency road noise from being sufficiently reduced. On the other hand, in a case where the cord tension in the normalizing step is greater than 6.7×10⁻²N/tex, the cord elastic modulus is increased, and the fatigue resistance of the cords is reduced.

### EXAMPLES

Tires of a Conventional Example 1, Comparative Examples 1 to 3, and Examples 1 to 9 were manufactured. The tires had a tire size of 225/60R18, had the basic structure illustrated in FIG. 1, and varied in the structure of the steel cords constituting the belt layer, the number of steel cords, the bending rigidity S of each of the belt layers per 50 mm width in the direction orthogonal to the longitudinal direction of the steel cords, the straightness of the wire strands constituting the inner layer of the steel cords, the type of organic fibers used in the organic fiber cords constituting the belt cover layer, and the elongation of the organic fiber cords under a load of 2.0 cN/dtex, as indicated in Tables 1 and 2.

In all examples, the belt cover layer has a jointless structure in which a strip formed by bunching one organic fiber cord (nylon 66 fiber cord or PET fiber cord) and covering the organic fiber cord with coating rubber is helically wound in the tire circumferential direction. The cord density in the strip was 50 cords/50 mm. In addition, the organic fiber cords (nylon 66 fiber cords or PET fiber cords) have a structure of 940 dtex/4 in Conventional Example 1 and have a structure of 1100 dtex/2 in the other examples.

For the section “Type of organic fibers” in Tables 1 and 2, a configuration using nylon 66 fiber cords is indicated as “N66”, and a configuration using PET fiber cords is indicated as “PET”.

The test tires were evaluated for the road noise performance and the durability of the belt layers against separation by using the evaluation method described below. The results are indicated in Tables 1 and 2.

### Road Noise Performance

The test tires were mounted on wheels having a rim size of 18×7J, mounted as front and rear wheels of a passenger vehicle (front wheel drive vehicle) having an engine displacement of 2500 cc, and inflated to an air pressure of 230 kPa. Further, a sound collection microphone was installed on an inner side of the window of the driver's seat, and a sound pressure level near a frequency of 315 Hz was measured in a case where the vehicle was driven at an average speed of 50 km/h on a test course formed of an asphalt road surface. Evaluation results are indicated as variations (dB) with respect to a reference corresponding to a Conventional Example.

### Durability

The test tires were mounted on wheels having a rim size of 18×7J, inflated to an internal pressure of 230 kPa, and held for two weeks in a chamber maintained at a chamber temperature of 60° C., the oxygen inside the chamber was released, and the chamber was filled with air to an internal pressure of 160 kPa. A drum testing machine having a smooth drum surface formed of steel and having a diameter of 1707 mm was used to run the pre-treated test tires 5000 km for 100 hours under fluctuating conditions including an ambient temperature of 38±3° C., a running speed of 50 km/hr, a slip angle of 0±3° , and a maximum load of 70±40%, with the load and the slip angle fluctuated by a rectangular wave of 0.083 Hz. After the running, the tires were cut open, and the separation length in the width direction was measured at ends of the belts in the belt width direction. Evaluation results are expressed as index values with the inverse of the measurement value in Conventional Example 1 being assigned as 100. Larger index values indicate a smaller separation length and more excellent durability against belt-edge-separation.

[Table 1-1]

| | | | Conventional | | |
|---|---|---|---|---|---|
| | | | Example 1 | Example 1 | Example 2 |
| Belt | Structure of steel cord | | 2 + 2 × 0.34 | 1 × 2 × 0.35 | 2 + 2 × 0.32 |
| layer | Number of cords | Number of | 32 | 49 | 35 |
| | | cords/50 mm | | | |
| | Bending rigidity S | N · mm²/50 mm | 17800 | 15200 | 15200 |
| | Straightness | mm/40 cm | 160 | — | 160 |

| | | | | |
|---|---|---|---|---|
| Belt | Type of organic fiber | N66 | PET | PET |
| cover | Elongation under load % | 7.5 | 2.8 | 2.8 |
| layer | of 2.0 cN/dtex | | | |

| | | | | |
|---|---|---|---|---|
| Road noise performance | dB | 0.0 | −2.5 | −2.5 |
| Durability | Index value | 100 | 102 | 104 |

[Table 1-2]

| | | | Example 3 | Example 4 | Example 5 |
|---|---|---|---|---|---|
| Belt | Structure of steel cord | | 2 + 2 × 0.25 | 2 + 2 × 0.25 | 2 + 2 × 0.25 |
| layer | Number of cords | Number of | | | |
| | | cords/50 mm | 42 | 42 | 42 |
| | Bending rigidity S | N · mm²/50 mm | 6800 | 6800 | 6800 |
| | Straightness | mm/40 cm | 160 | 120 | 90 |

| | | | | |
|---|---|---|---|---|
| Belt | Type of organic fiber | PET | PET | PET |
| cover | Elongation under load of 2.0% | 2.8 | 2.8 | 2.8 |
| layer | cN/dtex | | | |

| | | | | |
|---|---|---|---|---|
| Road noise performance | dB | −2.5 | −2.5 | −2.5 |
| Durability | Index value | 108 | 109 | 110 |

Table 2-1

| | | | Comparative | | | Comparative |
|---|---|---|---|---|---|---|
| | | | Example 1 | Example 6 | Example 7 | Example 2 |
| Belt | Structure of steel cord | | 2 + 2 × 0.32 | 2 + 2 × 0.32 | 2 + 2 × 0.32 | 2 + 2 × 0.32 |
| layer | Number of | Number of | 35 | 35 | 35 | 35 |
| | cords | cords/50 mm | | | | |
| | Bending | N · mm²/50 mm | 15200 | 15200 | 15200 | 15200 |
| | rigidity S | | | | | |
| | Straightness | mm/40 cm | 160 | 160 | 160 | 160 |
| Belt | Type of organic fiber | | PET | PET | PET | PET |

| | | | | | |
|---|---|---|---|---|---|
| cover | Elongation under | 1.8 | 2.2 | 3.8 | 4.3 |
| layer | load of 2.0 % | | | | |
| | cN/dtex | | | | |

| | | | | | |
|---|---|---|---|---|---|
| Road noise | dB | -2.8 | −2.7 | −0.5 | 0.3 |
| performance | | | | | |
| Durability | Index value | 90 | 103 | 104 | 104 |

Table 2-2

| | | | Example | Comparative | Example |
|---|---|---|---|---|---|
| | | | 8 | Example 3 | 9 |
| Belt | Structure of steel cord | | 2 + 2 × | 2 + 2 × 0.34 | 2 +1 × |
| layer | | | 0.34 | | 0.32 |
| | Number of cords | Number of cords/50 mm | 30 | 34 | 37 |
| | Bending rigidity S | N · mm²/50 mm | 16500 | 18800 | 7100 |
| | Straightness | mm/40 cm | 160 | 160 | 160 |
| Belt | Type of organic fiber | | PET | PET | PET |
| cover | | | | | |

| | | | | |
|---|---|---|---|---|
| layer | Elongation under load of 2.0 cN/dtex % | 2.8 | 2.8 | 2.8 |

| | | | | |
|---|---|---|---|---|
| Road noise performance | dB | -2.5 | −2.5 | −2.5 |
| Durability | Index value | 102 | 97 | 107 |

As can be seen in Tables 1 and 2, compared to the tire of Conventional Example 1 assigned as reference, the tires of Examples 1 to 9 provided improved road noise performance and improved durability against belt-edge-separation. On the other hand, in Comparative Example 1, the belt cover layer had an excessively small elongation under a load of 2.0 cN/dtex, thus precluding belt-edge-separation from being prevented. Consequently, sufficient durability was not achieved. In Comparative Example 2, the belt cover layer had an excessively large elongation under a load of 2.0 cN/dtex, thus preventing sufficient road noise performance from being achieved. In Comparative Example 3, an excessively high bending rigidity S precluded belt-edge-separation from being prevented, leading to failure to achieve sufficient durability.

1. A pneumatic radial tire comprising a tread portion extending in a tire circumferential direction and having an annular shape, a pair of sidewall portions respectively disposed on both sides of the tread portion, and a pair of bead portions each disposed on an inner side of the pair of sidewall portions in a tire radial direction, and a carcass layer mounted between the pair of bead portions, a plurality of belt layers disposed on an outer circumferential side of the carcass layer in the tread portion, and a belt cover layer disposed on an outer circumferential side of the belt layers,
the belt layers comprising steel cords arranged at an incline with respect to the tire circumferential direction in such a manner as to intersect one another between the layers, each of the belt layers having a bending rigidity of 16500 N·mm²/50 mm or less per 50 mm width in a direction orthogonal to a longitudinal direction of the steel cords, and
the belt cover layer comprising polyester fiber cords having an elongation of 2.0% to 4.0% under a load of 2.0 cN/dtex, the polyester fiber cords being helically wound along the tire circumferential direction.

2. The pneumatic radial tire according to claim 1, wherein the steel cords have a 2+N structure in which an outer layer comprising N wire strands is intertwined around an inner layer comprising two wire strands bunched, and a number N of the wire strands of the outer layer is from one to four.

3. The pneumatic radial tire according to claim 2, wherein the wire strands constituting the inner layer of the steel cords have a straightness of 120 mm/40 cm or less, and the bending rigidity of the belt layers is 7500 N·mm²/50 mm or less.
